(19) United States
(12) Patent Application Publication
(10) Pub. No.: US 2011/0225947 A1
(43) Pub. Date: Sep. 22, 2011

(54) SYSTEM AND METHODS FOR ALTERING AIR FLOW IN A COMBUSTOR

(76) Inventors: Benjamin Paul Lacy, Greer, SC (US); Roy Marshall Washam, Clinton, SC (US); Thomas Edward Johnson, Greer, SC (US)

(21) Appl. No.: 12/725,602

(22) Filed: Mar. 17, 2010

(51) Int. Cl. F23R 3/26; F02C 3/14; F02C 7/22

(52) U.S. Cl. 60/39.23; 60/752; 60/734

(57) ABSTRACT

A combustor assembly of a turbine engine is provided with a mechanical air regulation unit which selectively varies the amount of air being delivered into a combustion zone of the combustor based upon a pressure of a fuel being supplied to the combustor. A first type of air regulation unit would act to increase the amount of air entering the combustion zone when greater amounts of a high heat value fuel are being delivered to the fuel nozzles of the combustor. A second type of air regulation unit could act to decrease the amount of air entering the combustion zone when greater amounts of a low heat value fuel are being delivered into the combustor through fuel nozzles.

### BACKGROUND OF THE INVENTION

Turbine engines used in the electrical power generation industry typically include a compressor section, one or more combustors which may be arranged concentrically around the outside of the compressor section, and a turbine section which is located downstream from the compressor and the combustors.

Fuel is delivered into one or more combustion zones within the combustors via a plurality of fuel nozzles. The fuel nozzles are intended to deliver precisely controlled amounts of the combustible fuel, and to help mix the fuel with compressed air from the compressor section. The fuel air mixture is then ignited within the combustion zone, and the hot combustion gases exit the combustor into the turbine section to provide the motive power for the turbine engine.

Some turbine engines are designed to burn multiple different types of fuels. Regardless of the type of fuel being used, it is necessary to mix the fuel with a certain amount of air per unit volume of the fuel in order to achieve good combustion. If the local fuel/air ratio increases above an optimum value, meaning there is more than an optimum amount of fuel per unit volume of air, the mixture is said to be in fuel excess. Conversely, if the local fuel/air ratio decreases below the optimum value, meaning there is less than an optimum amount of fuel per unit volume of air, the mixture is said to be fuel lite.

When an engine is running with a local fuel excess in the combustion zone, meaning the local fuel/air ratio is higher than optimum, the local combustion temperature increases above the temperature that would exist if the fuel/air ratio were optimum. And the excess fuel/air ratio and the higher combustion temperature can lead to the generation of undesirable nitric oxide gases (NOX).

Conversely, when a turbine is running with a locally lite fuel/air ratio in the combustion zone, the combustion temperatures tend to be lower than the temperature that would exist if the fuel/air ratio was at optimum. And the lower then optimum fuel/air ratio and the lower local combustion temperature will be insufficient to burn out all of the undesirable CO gases.

Turbine engines used in the power generation industry must be capable of generating a range of power output so that the amount of electricity being generated can be matched to the demand. And this means that during some periods of time, the turbine will be lightly loaded, while during other periods of time, the turbine will be heavily loaded. In order to support these varying loads, one adjusts the amount of fuel being supplied to the combustors of the turbine.

Fuel is delivered into the combustors by a plurality of fuel nozzles that are mounted in each combustor. And it is relatively easy to vary the amount of fuel being delivered by the fuel nozzles into the combustors. However, it is more difficult to selectively vary the air splits being delivered at the combustion zone and downstream of the combustion zone.

When a turbine is being operated at high power, under a heavy load, the fuel nozzles must deliver a relatively large amount of fuel into the combustors so that the turbine can meet the load requirement. And because it is somewhat difficult control the amount of air being delivered into the combustion zone, this tends to result in the turbine running with an above optimum fuel/air mixture in the combustion zone. As noted above, this can result in a high combustion temperature, and the generation of undesirable NOX gases.

Conversely, when a turbine is operated at low power, to support a relatively light load, a relatively small amount of fuel is being delivered into the combustors by the fuel nozzles. And because it is difficult tovary the air splits to the combustion zone to properly match the amount of fuel being used, this tends to result in a less than optimum fuel/air mixture in the combustion zone. As noted above, this can result in a low combustion temperature. The lower combustion temperatures can result in not all of the CO gases being burned in the combustors, and the unburned CO gases are ultimately exhausted from the turbine, which is also undesirable.

Moreover, running with a locally less than optimum fuel/air mixture in the combustion zone can also negatively impact flame stability. Accordingly, when operating under leaner conditions, there is a danger that a combustor will experience a flameout.

Another somewhat related problem with fuel/air mixtures in turbine engines has to do with the fact that some turbines are designed to burn multiple types of fuel. In the past, turbines were generally run with relatively high heat value fuels, such as high methane content natural gases. In recent years, it has become more common for turbine operators to supply a turbine with a mixture of a relatively high heat value fuel such as natural gas and a relatively low heat value fuel such as syn-gas. Syn-gas and other low heat value fuels are generally less expensive. Also, syn-gas can be generated as a byproduct of waste treatment at a waste treatment plant. Thus, burning syn-gas in a power generating turbine is one way to recycle energy from waste.

In order to run a turbine at a certain load condition, it is necessary to use a greater volume of a low heat value fuel than of a high heat value fuel. Less air is required per unit volume of the low heat value fuel to achieve good complete combustion. Thus, for any given turbine load condition, when switching from a high heat value fuel to a lower heat value fuel, a greater volume of the low heat value fuel is required. Likewise, for certain lower heat content fuel, it may be desirable to use less air per unit volume of the lower heat value fuel to achieve good combustion.

As noted above, it is relatively easy to control the amount of fuel being delivered into a combustor via the fuel nozzles. As also noted above, it is difficult to vary the amount of air being supplied to the combustion zone.

During a typical turbine operation, the turbine would be started with a high heat value fuel, and the engine would be brought up to a steady state operational condition. Once that steady state condition has been achieved, the operator may begin to mix a certain quantity of a low heat value fuel into the high heat value fuel to create a mixture that is delivered into the combustor. Because a greater volume of the low heat value fuel is required to keep the engine at the load condition, a greater total volume of fuel will be delivered into the combustor. However, for the reasons given above, it may be desirable to simultaneously reduce the amount of air being supplied into the combustion zone per unit volume of fuel. Failure to reduce the amount of air per unit volume of fuel may result in an undesirably low fuel/air ratio in the combustion zone. And as noted above, this can result in flame instability, and incomplete burning of CO gases.

### BRIEF DESCRIPTION OF THE INVENTION

In a first aspect, the invention may be embodied in a fuel nozzle for a turbine engine that includes an elongated housing, a fuel delivery passageway that extends along at least a part of the length of the housing, an air delivery passageway that extends along at least a part of the length of the housing, and a fuel inlet that receives fuel from a fuel supply line and that communicates with the fuel delivery passageway. The fuel nozzle would also include an air regulation unit coupled to the fuel inlet, wherein the air regulation unit varies an amount of air that passes into the air delivery passageway based on a fuel pressure at the fuel inlet.

In a second aspect, the invention may be embodied in a combustor for a turbine engine that includes a combustor liner, a fuel nozzle mounted inside the combustor liner and coupled to a fuel supply line, and an air regulation unit coupled to the fuel supply line. The air regulation unit would act to vary a flow of air into a combustion zone of the combustor based on a fuel pressure in the fuel supply line.

In another aspect, the invention may be embodied in a method of controlling a flow of air into a combustion zone of a combustor of a turbine. The method would include sensing a fuel pressure in a fuel supply line that supplies fuel to the combustor, and varying a flow of air into the combustion zone based on the sensed fuel pressure.

### BRIEF DESCRIPTION OF THE DRAWINGS

FIG. 1 is a cross-sectional diagram of a typical combustor of a turbine engine;

FIG. 2 is a cross-sectional diagram of a combustor which includes air regulation units for varying the amount of air flowing into the combustion section of the combustor;

FIG. 3 illustrates a first type of an air regulation unit under a first operational condition;

FIG. 4 illustrates the regulation unit of FIG. 3 under a second operational condition

FIG. 5 illustrates a second type of an air regulation unit under a first operational condition;

FIG. 6 illustrates the air regulation unit of FIG. 5 under a second operational condition;

FIG. 7 illustrates a fuel delivery nozzle which includes air regulation units;

FIG. 8 illustrates a first type of mechanism that can be used to vary the amount of air flowing through a nozzle based on a fuel pressure under a first operational condition;

FIG. 9 illustrates the mechanism illustrated in FIG. 8 under a second operational condition;

FIG. 10 illustrates a second type of mechanism that can be used to vary the amount of air flowing through a nozzle based on a fuel pressure under a first operational condition;

FIG. 11 illustrates the mechanism illustrated in FIG. 10 under a second operational condition;

FIG. 12 is a partial cross-sectional view illustrating a first arrangement for movably mounting a fuel nozzle on a combustor to selectively vary an amount of air being delivered into a combustor;

FIG. 13 is a partial cross-sectional view illustrating a second arrangement for movably mounting a fuel nozzle on a combustor to selectively vary an amount of air being delivered into a combustor; and

FIG. 14 is a partial cross-sectional view showing a fuel nozzle with a movable element that is mounted on a combustor assembly.

### DETAILED DESCRIPTION OF THE INVENTION

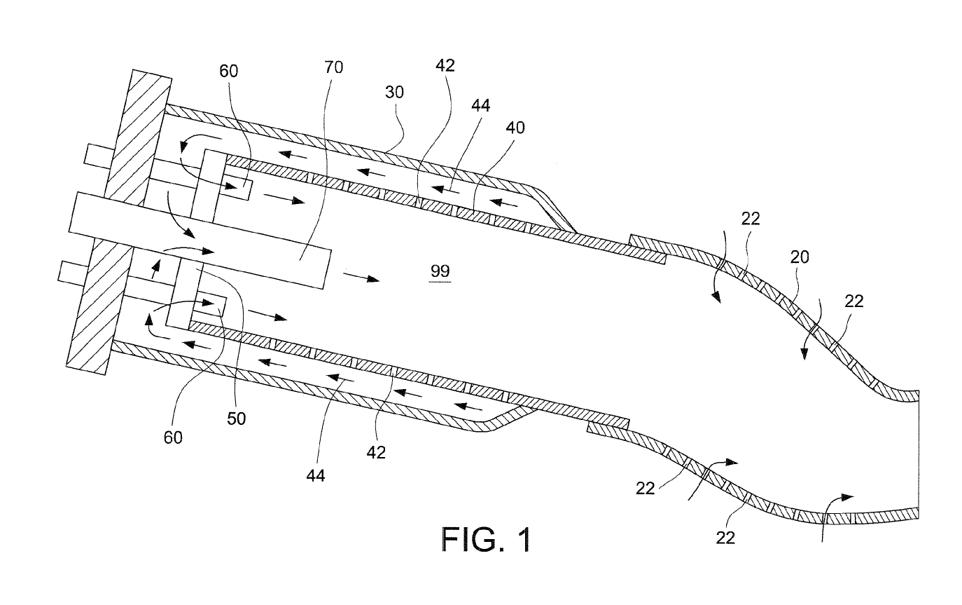

FIG. 1 illustrates a typical combustor assembly which is used in a turbine engine used in the power generation industry. The combustor assembly includes a transition duct 20 which routes combustion gases into the turbine section of the engine. An upper end of the transition duct 20 is attached to a combustor liner 40. A flow sleeve 30 is located concentrically around the combustor liner 40.

Compressed air from the compressor section of the turbine is routed into the annular space located between the flow sleeve 30 and the combustor liner 40. The arrows 44 in FIG. 1 illustrate the flow path of the compressed air.

At the upstream end of the combustor, a plurality of fuel nozzles 60 are mounted in a concentric ring around a combustor cap assembly 50. In some turbines, a secondary fuel nozzle 70 is located at the center of the combustor. In other turbines, the secondary fuel nozzle is not present or in contrast to the figure, may be flush or recessed relative to the cap. Both the primary fuel nozzles 60 and the secondary fuel nozzle 70 penetrate the combustor cap assembly 50 and extend outside the combustor.

Air from the compressor section of the turbine can enter the combustion zone 99 via a plurality of different paths. As shown by the arrows 44, the compressed air travels up the annular space between the flow sleeve 30 and the combustor liner 40. The compressed air must turn 180°. The air can flow through the nozzles to enter a combustion zone 99, or the air can pass through apertures in the combustor cap 50 to enter the combustion zone 99. The apertures in the combustor cap 50 can be provided to cool the combustor cap. Likewise, annular spaces in the combustor cap 50 may surround each of the fuel nozzles, to allow a flow of the air to pass down the exterior of the nozzles to help cool the nozzles.

In addition, dilution holes 22 and cooling holes can be located in the transition piece 20. This allows some of the air from the compressor to pass from an exterior of the transition piece into the interior of the transition piece. Likewise, dilution holes 42 in the combustor liner 40 can allow air to enter the combustion zone 99.

Fuel supplied by the fuel nozzles 60, 70 mixes with the compressed air and the fuel air mixture is ignited in the combustion zone 99.

As explained above, it is sometimes desirable to vary the amount of air which is being locally mixed with the fuel supplied by the fuel nozzles to achieve optimum combustion. The proper mixture of fuel and air provides good combustion efficiency and also reduces the creation of undesirable combustion gases.

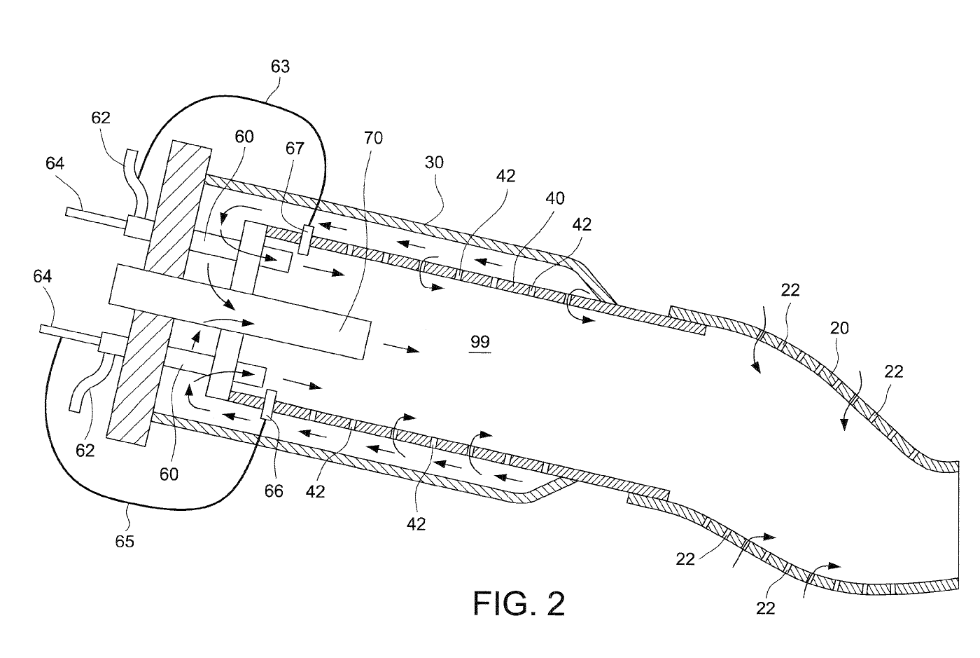

FIG. 2 illustrates a combustor which includes a plurality of air regulation units 66, 67. As will be explained below, the air regulation units are designed to selectively vary the amount of air being delivered into the combustor. In this embodiment, the air regulation units 66, 67 are mounted on the combustor liner 40. However, in alternate embodiments, the air regulation units could be mounted in other locations on the combustor assembly. For instance, the air regulation units could be located on the combustor flow sleeve 30, or on the combustor cap 50. The air regulation units could also be located at the downstream end of the combustion zone, such as on the transition piece 20.

As explained above, when the load demand on a turbine increases, it is necessary to deliver a larger amount of fuel into the combustor to satisfy the higher load. As also explained above, when greater amounts of fuel are being delivered into the combustor, it is desirable to increase the amount of air being delivered into the combustion zone to avoid running the turbine at an undesirably high fuel/air ratio, which can lead to the generation of undesirable NOX gases. The first air regulation units 67 in the combustor illustrated in FIG. 2 are designed to open a supplemental air passageway into the combustor when greater amounts of fuel are being supplied to the combustor.

Delivering a greater amount of fuel through the nozzles means that the pressure in the fuel lines will increase. Conversely, when lesser amounts of fuel are being delivered into the combustor, the fuel pressure decreases. Because fuel pressure varies depending on the rate at which fuel is being delivered into the combustor, the fuel pressure is used to actuate a mechanical mechanism in the first air regulation units 67 to selectively vary the amount of air being delivered into the upstream end of the combustor. The design of the air regulators can be such that air flow varies linearly or non-linearly with the fuel pressure as desired to optimize operation.

In the embodiment illustrated in FIG. 2, each of the primary fuel nozzles 60 is supplied with two different types of fuel through a first fuel supply line and a second fuel supply line 64. The first fuel supply line 62 is used to deliver a high heat value fuel to the primary fuel nozzles 60, such as natural gas. The second fuel supply line 64 is used to deliver a relatively low heat value fuel to the fuel nozzles, such as syn-gas.

If the turbine is operated on high heat value fuel, such as natural gas, one would like to increase the amount of air being delivered into the combustion zone as the amount of fuel being delivered increases. And the varying pressure in the first fuel supply line 62 is used to accomplish this.

In the embodiment illustrated in FIG. 2, the first air regulation units 67 are coupled to the first fuel delivery line 62 via a pressure line 63. The pressure line 63 communicates the pressure in the first fuel delivery line 62 to the first air regulation unit 67. As the pressure in the first fuel delivery line 62 increases, the rise in pressure causes a mechanism in the first air regulation unit 67 to open a supplemental air passageway to allow additional air to enter the upstream end of the combustor.

Although FIG. 2 shows only a single first air regulation unit 67, in an actual embodiment, a plurality of first air regulation units 67 would be mounted around the combustor in a ring that extends around the exterior of the combustor liner 40. In alternate embodiments, additional first air regulation units 67 might be located on the combustor liner 40 at positions downstream of the one shown in FIG. 2. Likewise, one or more first air regulation units 67 could instead be mounted on the flow sleeve 30, or on the combustor cap 50. Regardless of where they are mounted, it would be desirable to locate the first air regulation units 67 so that as they open supplemental air passageways, the additional air being introduced into the interior of the combustor is uniformly distributed around the combustor.

An embodiment of the first air regulation unit 67 is illustrated in a functional fashion in FIGS. 5 and 6. As shown therein, the pressure line 63 leading to the first fuel delivery line 62 would open into a chamber 177 located within the first air regulation unit. When the pressure of the fuel in the pressure line 63 increases, it would act against a piston 178 located within the chamber 177. The increased pressure would cause the piston 178 to move upward against the action of a biasing spring 179. The design of the biasing spring could be such as to vary the airflow linearly or non-linearly with fuel pressure based on optimizing performance. This, in turn, would raise a blocking unit 175 located within an airflow passage 176.

When an air regulation unit as illustrated in FIGS. 5 and 6 is coupled to the first fuel delivery line 62 via the pressure line 63, it is possible to alter the amount of air flowing through the airflow passage 176 based on the pressure of the first high value fuel. Accordingly, when lesser amounts of the first high heat value fuel is being supplied to the nozzles at a relatively low pressure, the first air regulation unit would be configured as illustrated in FIG. 5. The biasing spring 179 will have pushed the blocking unit 175 down into the air passage 176 to partially or completely block the air passage 176. However, when the pressure of the first high heat value fuel increases, as a greater amount of the fuel is delivered to the fuel nozzles, the higher fuel pressure will push the piston 178 upward and raise the blocking unit 175 to allow a greater amount of air to flow through the air passage 176. The design could be such as to vary the flow linearly or non-linearly with fuel pressure.

The mechanical linkage illustrated in FIGS. 5 and 6, which operates based upon the fuel pressure in the fuel supply line 62, provides a simple mechanical means of varying the amount of air entering the combustion zone to achieve optimum combustion conditions. There is no need for any separate electronically controlled flow mechanism. Instead, the fuel pressure alone will suffice to automatically adjust the airflow to achieve optimum combustion conditions.

The second air regulation unit 66 is designed to deal with the air supply problems than can occur when a turbine is run with low heat value fuel. As explained above, when a relatively low heat value fuel such as syn-gas is mixed with natural gas, or is used exclusively, it is necessary to use a greater volume of the low heat value fuel, as compared to the high heat value fuel, to maintain the turbine at a certain operating condition. It also may be desirable to use less air per unit volume of the low heat value fuel, depending on the fuel's composition, in the combustion zone to avoid running the turbine in an undesirably lean condition, which can result in flame instability and incomplete burning of undesirable CO gases. And the more low heat value fuel that is used, the more one may like to reduce the amount of air being supplied into the combustion zone.

The second air regulation unit is designed to selectively vary the air being introduced into the combustor based on the pressure in the second fuel delivery line 64, which provides the low heat value fuel to the fuel nozzles 60/70. As with the first air regulation units 67 described above, in an actual embodiment of a combustor, the second air regulation units 66 would be mounted in a ring around the exterior of the combustor. Also, additional second air regulation units 66 could be located downstream of the one shown in FIG. 2. Likewise, second air regulation units 66 could also be mounted on the flow sleeve 30 and/or on the combustor cap 50. As with the first air regulation units 67, the second air regulation units 66 would be located on the combustor so that as the mechanism operates to vary the air splits into the combustor, the varied flow occurs substantially uniformly axially around the combustor.

A pressure line 65 couples the second fuel delivery line 64 to the second air regulation units 66. And the varying pressure is used to control a mechanical mechanism in the second air regulation unit 66 to selectively close off a supplemental air supply passage that admits air into the combustor. As the pressure of the low heat value fuel increases, indicating that greater amounts of the low heat value fuel are being mixed into the fuel delivered to the nozzles 60/70, the supplemental air passageway is gradually closed off.

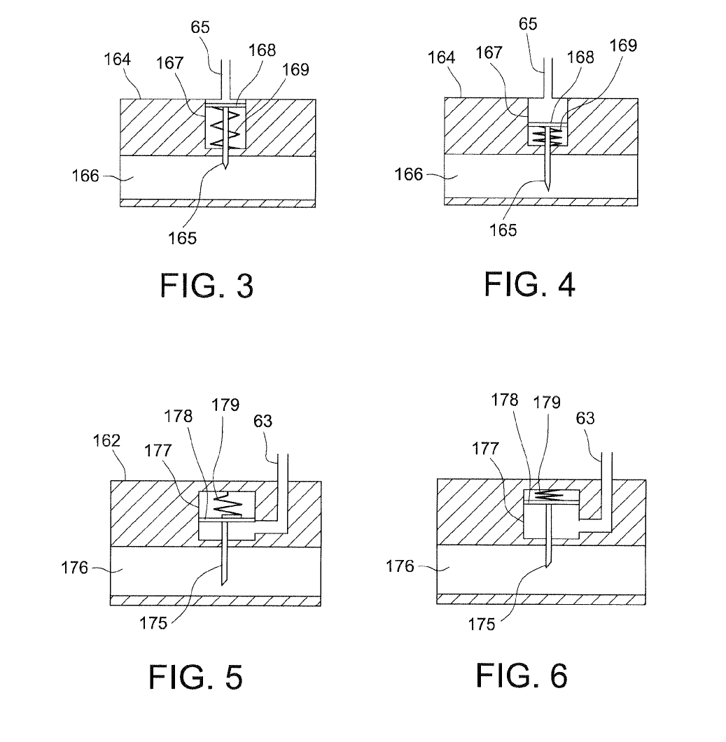

The second air regulation unit 66 could be configured as illustrated in FIGS. 3 and 4 of the application. FIGS. 3 and 4 illustrate a mechanism similar to the one described above, however, the air flow into the combustion zone is varied in the opposite manner.

As shown in FIG. 3, when a relatively low pressure is being applied to the piston 168 through the pressure line 65, the biasing member 169 pushes the plunger 168 upward so that the blocking unit 165 is almost fully retracted out of the airflow passage 166. However, when greater amounts of the low heat value fuel are being supplied, and the pressure in the pressure line 65 increases, that greater pressure will push on the top of the piston 168 to force the piston and the blocking unit 165 downwards against the pressure of the biasing member 169. As a result, the blocking member 165 will close off the airflow passage 66 to reduce the amount of compressed air which is entering the combustion zone.

A device as illustrated in FIGS. 3 and 4 provides a simple mechanical means for varying the airflow into the combustion zone to achieve optimum combustion conditions when a relatively low heat value fuel is being used in the combustor.

The mechanisms illustrated in FIGS. 3-6 are only intended to illustrate the concept. In an actual embodiment used in a turbine engine, the air regulation unit could be configured in multiple different ways so long as they still achieve the same flow control over the air entering the combustion zone based on the pressure of fuel in fuel supply lines. Air flow variation could be setup to vary linearly or non-linearly with fuel pressure as desired to optimize performance. Accordingly, the details illustrated in FIGS. 3-6 are not intended to be in way limiting. Particular embodiments of air regulation units could be configured in multiple different ways.

For instance, in the embodiments described above, the air regulation units are located at the upstream end of the combustor. In alternate embodiments, the air regulation units could be located at the downstream end of the combustor, for instance, on the transition piece 20. However, when the air regulation units are located at the downstream end of the combustor, they would need to operate in the opposite fashion.

For instance, when an air regulation unit is located on the transition piece 20, and connected to the fuel supply line 62 that delivers high heat value fuel into the combustor, the air regulation unit would need to close off a supplementary air passage as the pressure of the high heat value fuel increases. This will reduce the amount of air entering the combustor at the downstream end, which will have the effect of increasing the amount of air entering at the upstream end, to avoid an undesirably rich fuel air ratio in the combustion zone.

Conversely, when an air regulation unit is located on the transition piece 20, and connected to the fuel supply line 64 that delivers low heat value fuel into the combustor, the air regulation unit would need to open a supplementary air passage as the pressure of the low heat value fuel increases. This will increase the amount of air entering the combustor at the downstream end, which will have the effect of decreasing the amount of air entering at the upstream end, to avoid an undesirably lean fuel air ratio in the combustion zone.

In the embodiments described above, the air regulation units directly control the amount of air flowing into the combustion zone 99. In alternate embodiments, similar air regulation units could be used to control the amount of air flowing through and/or around the exterior of the fuel nozzles themselves.

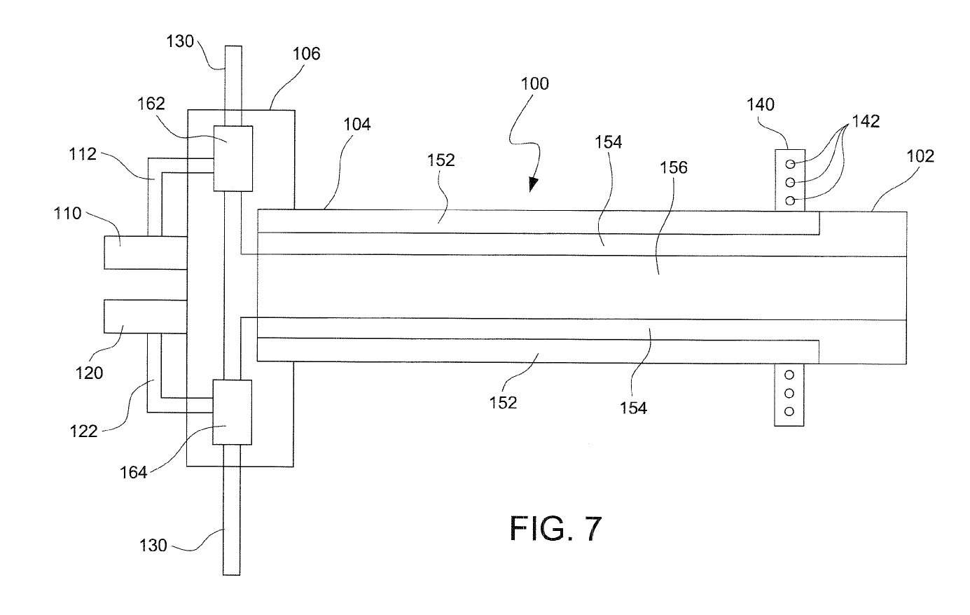

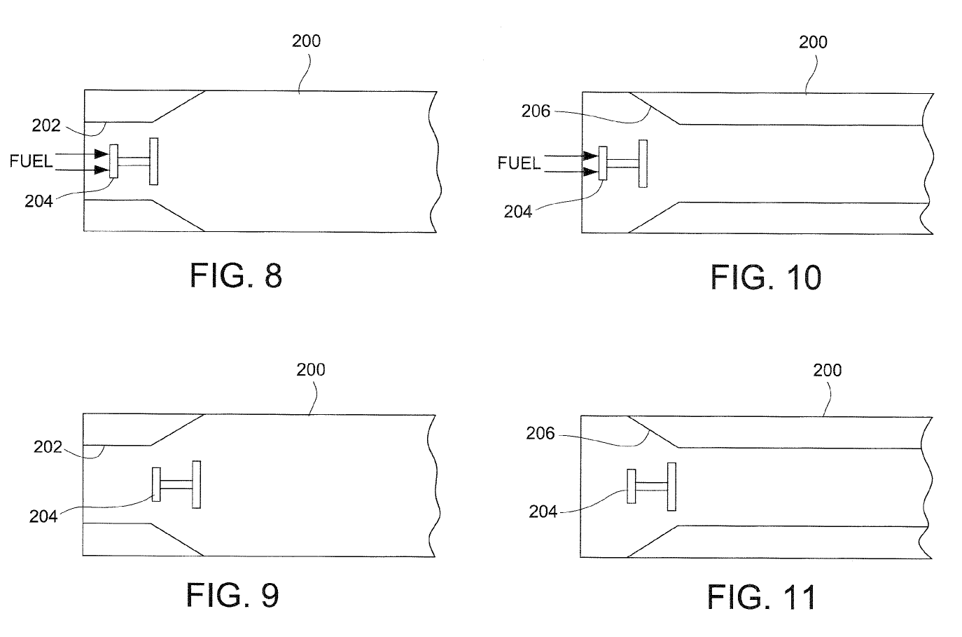

In the following description, FIG. 7 will be used to illustrate the basic concept of controlling air flow in the nozzles. Thereafter, some examples of mechanisms which could be used to control air flow through and/or around a nozzle will be described with reference to FIGS. 8-14.

In many nozzles, air flows through the nozzle itself. The air may be mixed with fuel within the nozzle, or the air may exit the downstream end of the nozzle, and then mix with fuel outside the nozzle. FIG. 7 illustrates a functional diagram of a fuel nozzle. This diagram is not intended to resemble an actual nozzle used in the turbine. Instead, the elements within the nozzle illustrated in FIG. 7 are provided as functional blocks. In an actual fuel nozzle, the functions performed by the functional blocks could be implements in numerous different ways.

As shown in FIG. 7, the fuel nozzle 100 includes an outer housing 104. A plurality of fuel and air passageways are located within the outer housing 104.

A primary fuel delivery passageway 152 runs down the length of the nozzle. The primary fuel passageway 152 delivers fuel to a plurality of radially extending fuel injectors 140. Each of the radially extending fuel injectors 140 includes a plurality of fuel apertures 142. The fuel delivered through main fuel passageway 152 exits through the fuel apertures 142 directly into the flow of compressed air running down the exterior of the fuel nozzle. In alternate embodiments, the fuel apertures could be formed along exterior of the body, and/or the fuel apertures could be part of swirler mechanisms mounted on the exterior of the nozzle. The swirler mechanisms could induce air flowing along the exterior of the nozzle to swirl around the nozzle, which can help to mix the fuel with the air before it is ignited in the combustion zone.

In the embodiment illustrated in FIG. 7, an additional fuel passageway 154 is provided to deliver fuel to the distal end 102 of the nozzle. The fuel nozzle shown in FIG. 7 also includes an air delivery passageway 156 that delivers air to the distal end 102 of the nozzle. In actual embodiments of fuel nozzles, the fuel passageway 154 and the air delivery passageway 156 could have varying configurations. Also, although only one fuel delivery passageway 154 and one air delivery passageway 156 is shown, in an actual embodiment, multiple fuel delivery passageways and multiple air delivery passageways could be provided. Further, although the passageways are shown as separated in FIG. 7, in actual embodiments, the fuel and air delivery passageways might come together in the nozzle to allow the fuel and air to mix in the nozzle.

The first air delivery passageway 156 is coupled to a first air regulation unit 162 and a second air regulation unit 164. An air inlet line 130 is coupled to the first and second air regulation units 162, 164. Although the air inlet line 130 is illustrated as coming from the side, as will be described later, in an actual nozzle, the air inlet might simply be an entrance opening in the nozzle that is positioned to receive a flow of compressed air from the compressor.

A first fuel supply line 110 supplies a high heat value fuel to the nozzle. A pressure line 112 connects the first air regulation unit 162 to the first fuel supply line 110. A fuel pressure within the first fuel supply line 110 is communicated to the first air regulation unit 162 via the pressure line 112. A rise in the fuel pressure in the fuel supply line 110 would cause the first air regulation unit 162 to increase the amount of air flowing into the air delivery passageway 156. A mechanism as illustrated in FIGS. 5 and 6 could be used as the first air regulation unit 162.

A second fuel supply line 120 could be used to deliver a relatively low heat value fuel to the fuel nozzle. The pressure line 122 would communicate a fuel pressure in the second fuel supply line 120 to the second air regulation unit 164. An increase in the fuel pressure in the second fuel supply line 120 would cause the second air regulation unit 164 to decrease the amount of compressed air flowing into the air delivery passageway 156. A mechanism as illustrated in FIGS. 3 and 4 could be used as the second air regulation unit 164.

The two air regulation units 162 and 164 would act to automatically adjust the amount of air passing through the nozzle and that is then introduced into the combustion zone of a combustor. The first air regulation unit 162 would act to introduce additional air when greater amounts of the high heat value fuel are being supplied, to avoid an above optimum fuel/air mixture. Likewise, when greater amounts of a low heat value fuel are being introduced into the combustor, depending on the composition of that fuel the second air regulation unit 164 could be utilized to decrease the amount of air being supplied to avoid operating with an undesirably lean fuel/air mixture.

In an actual fuel nozzle, one or more air regulation units could be positioned at the entrance of the nozzle to control the flow of air into the nozzle. FIGS. 8 and 9 illustrate a first type of device that performs this function. As shown therein, the air entrance port 202 has a first diameter at the entrance to the nozzle, and the diameter increases the deeper one progresses into the nozzle. A movable plunger 204 is positioned in the entrance. The movable plunger is biased towards the upstream end of the nozzle by a biasing element, such as a spring.

A leading or upstream end of the movable plunger 204 would be acted on by a high heat value fuel entering the nozzle. Under light load conditions, lesser amounts of fuel would act against the movable plunger 204, and the force of the biasing member would keep the plunger 204 positioned towards the upstream end of the nozzle. As a result, the downstream end of the movable plunger would partially block the entrance to the nozzle, limiting the amount of air passing through the nozzle.

When the turbine is more heavily loaded, and greater amounts of a high heat value fuel are flowing into the nozzle, the greater force of the fuel flow would act against the biasing member to push the movable plunger farther into the nozzle in the downstream direction. As shown in FIG. 9, this would cause the downstream end of the movable plunger 204 to move into the portion of the entrance port 202 having a greater diameter. And this would allow a greater amount of air to flow into and through the nozzle. Thus, the mechanism illustrated in FIGS. 8 and 9 would act like the first air regulation unit illustrated in FIGS. 5 and 6, which increases the amount of air entering the combustion zone when greater amounts of a high heat value fuel are being burned in the turbine. The design could be such that air flow could be varies linearly or non-linearly with fuel pressure as desired to optimize performance.

FIGS. 10 and 11 illustrate another type of mechanism that could be used to regulate air flow according to the amount of low heat value fuel that is being burned if required based on the composition of that fuel. As shown in these figures, the entrance 202 to the nozzle has a diameter that gradually decreases the greater the depth into the nozzle. A movable plunger 204 is still mounted at the entrance, and a biasing member would bias the movable plunger 204 toward the upstream direction. In this embodiment, the plunger 204 would be acted upon by a flow of a low heat value fuel.

In the embodiment illustrated in FIGS. 10 and 11, when lesser amounts of the low heat value fuel are flowing into the nozzle, the biasing member would hold the movable plunger 204 at the upstream end of the nozzle, as shown in FIG. 10. This would ensure that the air gap between the downstream end of the plunger 204 and the entrance passageway 202 would remain relatively large, allowing a greater amount of air to enter the nozzle, and pass into the combustion zone.

When greater amounts of the low heat value fuel are entering the nozzle, the greater fuel pressure of the low heat value fuel will push the movable plunger 204 deeper into the nozzle, as illustrated in FIG. 11. And in this position, the downstream end of the plunger 204 would close off a greater portion of the air gap between the entrance 202 and the plunger 204, thereby reducing the airflow through the nozzle. Thus, the mechanism illustrated in FIGS. 10 and 11 would operate like the air regulation unit illustrated in FIGS. 3 and 4, to decrease the amount of air being introduced into the combustion zone when greater amounts of the low heat value fuel are being burned in the turbine.

The plunger mechanisms illustrated in FIGS. 8-11 are only intended to be functional depictions of how such a mechanism could be configured. Actual implementations of this mechanism could take many forms. For instance, the plunger mechanism might be located at the entrance to the nozzle, or such mechanisms could be individually located in each air flow passageway through a nozzle.

Likewise, the plunger could be moved within the nozzle in multiple different ways. The fuel could directly impact the upstream end of the plunger, as described above, or the pressure in a fuel delivery line could cause the plunger to move in some other fashion. Regardless, the concept is for the fuel pressure to act through a mechanical device to selectively vary the airflow. Airflow may be varied linearly or non-linearly with fuel pressure as desired to optimize performance.

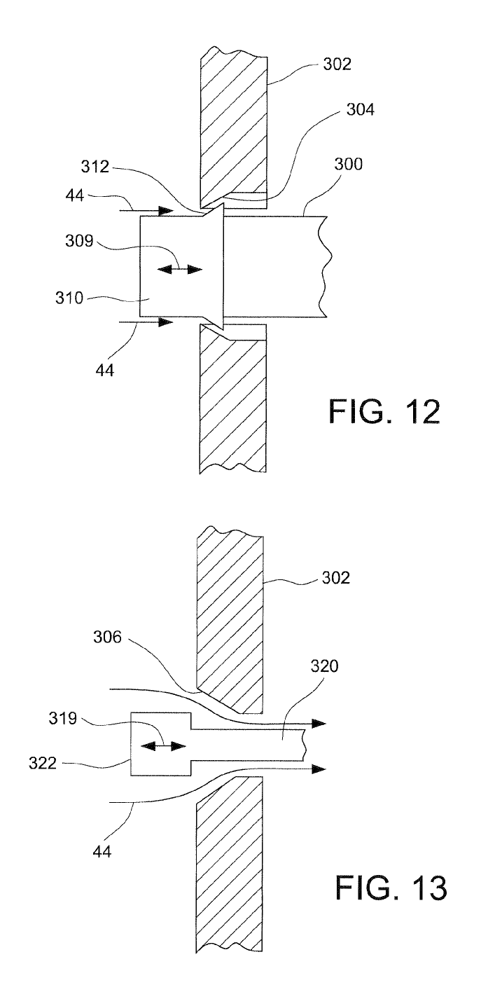

The mechanisms illustrated in FIGS. 8-11 are intended to selectively vary the flow of air through a nozzle. FIGS. 12 and 13 illustrate mechanisms that can be used to selectively vary a flow of air passing along the exterior of a nozzle for use when the combustion zone is somewhat downstream of the nozzle exit such as for the primary nozzles in a system that makes use of a centrally located secondary nozzle.

FIG. 12 illustrates a nozzle mounted on a combustor cap 302. A small air gap 312 is maintained between the exterior of the nozzle and the aperture 304 in the combustor cap 302 in which the nozzle is mounted. This air gap 312 allows a flow of air to pass along the exterior periphery of the nozzle, and this airflow cools the nozzle, and then passes into the combustion zone in the combustor.

The aperture 304 in which the nozzle is mounted has an angled surface such that a diameter of the aperture 304 increases as one progresses deeper into the aperture, in the downstream direction. The exterior of the nozzle also has an angled surface that matches the angled surface of the aperture 304.

The nozzle is movably mounted in the combustor cap 302 such that the nozzle can move in the direction of arrows 309. A biasing member would be provided to bias the nozzle toward the upstream direction. The force of a high heat value fuel would act upon the nozzle to cause the nozzle to move in the downstream direction. When a lesser amount of the high heat value fuel is flowing into the nozzle, the nozzle would be positioned towards the upstream end of its movable range, which would maintain a relatively small air gap 312 between the exterior of the nozzle and the aperture 304 in the combustor cap 302. This would ensure that a relatively small amount of air is allowed to flow through the air gap, and into the combustion zone of the combustor.

When greater amounts of the high heat value fuel are being delivered to the nozzle, the greater fuel pressure would cause the nozzle to move in the downstream direction, against the force of the biasing member. And when the nozzle moves in the downstream direction, the air gap 312 would increase, which would allow a greater amount of air to flow through the gap and into the combustion zone. Thus, the mechanism would selectively vary the airflow according to the pressure of a high heat value fuel, similar to the air regulation unit illustrated in FIGS. 5 and 6.

The mechanism illustrated in FIG. 13 could be used to selectively vary the airflow according to the pressure of a low heat value fuel. In this device, the nozzle 322 would also be movably mounted in the combustor cap 302 so that the nozzle can move in the direction of arrows 319. Likewise, a biasing member would bias the nozzle 322 toward the upstream end. In this mechanism, however, the walls of the aperture in which the nozzle is mounted would be angled such that the diameter of the aperture decreases in the downstream direction.

When lesser amount of the low heat value fuel are flowing, the biasing member would hold the nozzle 322 at the upstream end of its travel, and a greater amount of air would be allowed to flow between the nozzle and the combustor cap. When the amount of the low heat value fuel increases, the pressure of the fuel would cause the nozzle to move in the downstream direction, which would act to reduce the gap between the exterior of the nozzle and the aperture in the combustor cap 302. Thus, as greater amounts of the low heat value fuel are burned, the amount of air flowing into the combustion zone would decrease. Thus, this mechanism would operate like the air regulation mechanism illustrated in FIGS. 3 and 4.

The mechanisms illustrated in FIGS. 12 and 13 are intended to be illustrative only. In an actual embodiment, the mechanism could act to cause the nozzle to move in multiple different ways. In the most simple embodiments, the flow of fuel into the nozzle would be used to move the nozzle with respect to the combustor cap. In more complex embodiments, the fuel pressure could act through various mechanical devices to cause the nozzle to move with respect to the combustor cap.

Also, in some embodiments, the entire nozzle might move with respect to the combustor cap, while in other embodiments, only the portion of the nozzle that is located in the aperture of the combustor cap might move. In still other embodiments, the nozzles themselves might remain stationary, and the combustor cap might move with respect to the nozzles.

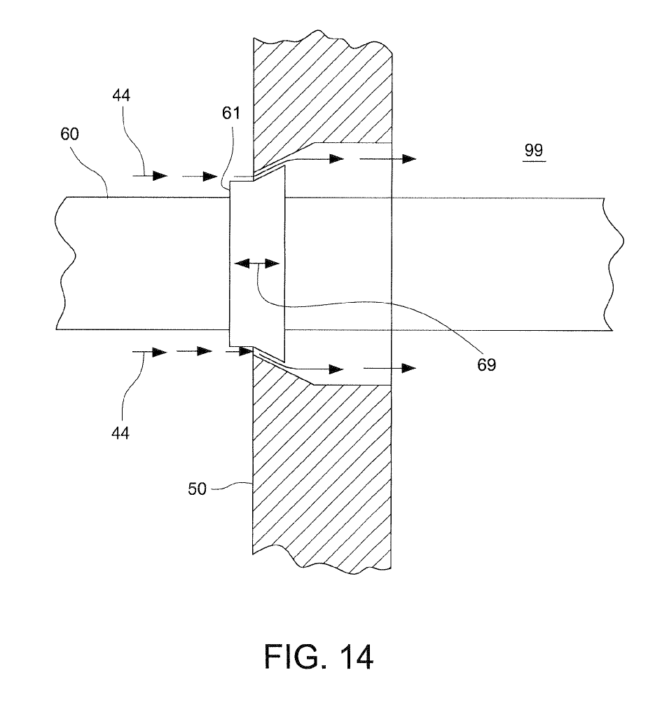

In the mechanisms illustrated in FIGS. 12 and 13, the mechanism could selectively vary airflow based on either the pressure of a high heat value fuel, or the pressure of a low heat value fuel. FIG. 14 illustrates a mechanism that selectively varies the amount of air flowing around the exterior of a nozzle based on both fuel pressures.

In the mechanism illustrated in FIG. 14, a movable collar 61 is mounted on the exterior of a nozzle 60. The movable collar 61 is capable of moving in the direction of arrows 69 along the length of the fuel nozzle 60 relative to the cap 50. Depending on the design, the collar and the nozzle could move as a unit or the collar alone could move independent of the nozzle. An angled surface on the exterior of the movable collar cooperates with a corresponding angled interior surface on the aperture in the combustor cap 50. Accordingly, when the movable collar 61 moves in the downstream direction, the movement opens an airflow passageway located between the exterior of the movable collar 61 and the interior angled surface on the combustor cap assembly 50. Conversely, if the movable collar 61 moves in the upstream direction, the movement decreases the size of the airflow passageway to reduce the airflow through the airflow passageway.

One or more simple mechanical mechanisms could be used to cause the movable collar 61 to move in the upstream and downstream directions based upon the pressures of high and low heat value fuels.

A first mechanical air regulation mechanism coupled to a high heat value fuel supply line would cause the movable collar 61 to move in the downstream direction when the pressure in the high heat value fuel line increases. This would increase the amount of air entering the combustion zone of the turbine.

A second air regulation mechanism coupled to a low heat value fuel supply line would cause the movable collar 61 to move in the upstream direction as the pressure in the low heat value fuel supply line increases. This would decrease the amount of air flowing into the combustion zone of the turbine.

Although the two mechanisms would act upon the movable collar in opposing directions, by providing both mechanisms, the airflow can be selectively varied based upon both the pressure of a high heat value fuel and the pressure of a low heat value fuel.

In alternate embodiments, the movable collar 61 could be coupled only to a high heat value fuel supply line, or only to a low heat value supply line. Further, some sort of biasing mechanism could ensure that the movable collar 61 always returns to a central or neutral position when the movable ring is not being moved in one direction or another by a pressure in a fuel delivery line.

For systems where the combustion zone is immediately at the nozzle exit such as in systems that do not include a centrally mounted secondary nozzle, the utilization of the mechanisms illustrated in FIGS. 12, 13 and 14 would reverse. That is, something like the mechanism illustrated in FIG. 13 would be used to reduce air flow around the nozzle, thereby forcing more air through the nozzle when the flow of the high heat value fuel is increased. Conversely, something like the mechanism illustrated in FIG. 12 would be used to bypass air around the nozzle, reducing air flow through the nozzle, when more low heating value fuel is used, if required based on the composition of the fuel.

Devices similar to the ones described above could be utilized if instead of air, oxygen or oxygen enriched air is used, or if some other oxygen/air combination gas is used.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A fuel nozzle for a turbine engine, comprising:
an elongated housing;
a fuel delivery passageway that extends along at least a part of the length of the housing;
an air delivery passageway that extends along at least a part of the length of the housing;
a fuel inlet that receives fuel from a fuel supply line and that communicates with the fuel delivery passageway; and
an air regulation unit coupled to the fuel inlet, wherein the air regulation unit varies an amount of air that passes into the air delivery passageway based on a fuel pressure or fuel pressure differential at the fuel inlet.

2. The fuel nozzle of claim 1, wherein the air regulation unit increases the flow of air into the air delivery passageway when the fuel pressure or fuel pressure differential at the fuel inlet increases.

3. The fuel nozzle of claim 1, wherein the air regulation unit decreases the flow of air into the air delivery passageway when the fuel pressure or fuel pressure differential at the fuel inlet increases.

4. The fuel nozzle of claim 1, wherein the air regulation unit varies the flow of air into the air delivery passageway in a linear manner based on the fuel pressure or fuel pressure differential at the fuel inlet.

5. The fuel nozzle of claim 1, wherein the air regulation unit varies the flow of air into the air delivery passageway in a non-linear manner based on the fuel pressure or fuel pressure differential at the fuel inlet.

6. The fuel nozzle of claim 1, wherein the fuel inlet comprises a first fuel inlet, wherein the air regulation unit comprises a first air regulation unit, and wherein the first air regulation unit varies an amount of air that passes into the air delivery passageway in a first manner based on the fuel pressure or fuel pressure differential at the first fuel inlet, the fuel nozzle further comprising:
a second fuel inlet; and
a second air regulation unit that is coupled to the second fuel inlet, wherein the second air regulation unit varies an amount of air that passes into the air delivery passageway in a second manner based on a fuel pressure or fuel pressure differential at the second fuel inlet.

7. The fuel nozzle of claim 6, wherein the second manner is opposite to the first manner.

8. The fuel nozzle of claim 6, wherein the first air regulation unit increases the flow of air into the air delivery passageway when the fuel pressure or fuel pressure differential at the first fuel inlet increases, and wherein the second air regulation unit decreases the flow of air into the air delivery passageway when the fuel pressure or fuel pressure differential at the second fuel inlet increases.

9. The fuel nozzle of claim 6, wherein the air delivery passageway comprises a first air delivery passageway and a second air delivery passageway, wherein the first air regulation unit controls a flow of air into the first air delivery passageway and wherein the second air regulation unit controls a flow of air into the second air delivery passageway.

10. A combustor for a turbine engine, comprising:
a combustor liner;
a fuel nozzle mounted inside the combustor liner and coupled to a fuel supply line; and
an air regulation unit coupled to the fuel supply line, the air regulation unit varying a flow of air into a combustion zone of the combustor based on a fuel pressure or fuel pressure differential in the fuel supply line.

11. The combustor of claim 10, wherein the air regulation unit increases the flow of air into the combustion zone when the fuel pressure or fuel pressure differential in the fuel supply line increases.

12. The combustor of claim 10, wherein the air regulation unit decreases the flow of air into the combustion zone when the fuel pressure of fuel pressure differential in the fuel supply line increases.

13. The combustor of claim 10, wherein the fuel nozzle is coupled to first and second fuel supply lines for supplying first and second types of fuel, respectively, to the fuel nozzle, wherein the air regulation unit varies a flow of air into the combustion zone in a first manner based on a fuel pressure or fuel pressure differential in the first fuel supply line and wherein the air regulation unit varies a flow of air into the combustion zone in a second manner based on a fuel pressure or fuel pressure differential in the second fuel supply line.

14. The combustor of claim 13, wherein the first manner is different from the second manner.

15. The combustor of claim 13, wherein the first manner is opposite to the second manner.

16. A method of controlling a flow of air into a combustion zone of a combustor of a turbine, comprising:
sensing a fuel pressure or fuel pressure differential in a fuel supply line that supplies fuel to the combustor; and
varying a flow of air into the combustion zone based on the sensed fuel pressure or fuel pressure differential.

17. The method of claim 16, wherein first and second fuel supply lines supply first and second types of fuel, respectively, to the combustor, wherein the varying step comprises:
varying the air flow into the combustion zone in a first manner when a pressure or fuel pressure differential in the first fuel supply line increases; and
varying the air flow into the combustion zone in a second manner when a pressure or pressure differential in the second fuel supply line increases, wherein the first manner is different from the second manner.

18. The method of claim 17, wherein the first manner is opposite to the second manner.

19. The method of claim 17, wherein when the pressure or pressure differential in the first fuel supply line increases, the varying step comprises increasing the flow of air into the combustion zone, and wherein when the pressure or pressure differential in the second fuel supply line increases, the varying step comprises decreasing the flow of air into the combustion zone.

20. The method of claim 19, wherein the flow of air into the combustion zone can simultaneously vary due to simultaneous pressure or pressure differential changes in both the first and second fuel supply lines.
